(19) United States
(12) Patent Application Publication
(10) Pub. No.: US 2009/0216555 A1
(43) Pub. Date: Aug. 27, 2009

(54) SYSTEM, METHOD AND COMPUTER PROGRAM PRODUCT FOR PERFORMING AUTOMATIC SURVEILLANCE AND TRACKING OF ADVERSE EVENTS

(75) Inventors: Andrea Claire Mitchell, Denver, CO (US); Deborah J. Bulger, Millbury, MA (US); Anne Coultas, Aurora, CO (US); Kathleen C. Aller, Gaithersburg, MD (US); Patricia Elder, Florence, MA (US); Alice M. Gasowski, Boulder, CO (US); Timothy Yeager, Baltimore, MD (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Automation Inc.

(21) Appl. No.: 12/035,478

(22) Filed: Feb. 22, 2008

(51) Int. Cl. G06Q 10/00

(52) U.S. Cl. 705/3

(57) ABSTRACT

A system, method and computer program product are provided for automatically detecting and tracking adverse events. The system may include one or more data sources configured to provide a combination of clinical, operational and financial data associated with each of a plurality of patients. The system may further include a network entity configured to receive at least part of the combination of data and to apply one or more trigger rules to the combinations of data to identify one or more suspected adverse events. The network entity may further be configured to receive an indication of one or more confirmed adverse events from among the suspected adverse events, and to automatically compile at least part of the combination of data associated with respective patients in association with which the confirmed adverse events occurred. The system may further include a user device configured to enable performance of a root cause analysis of the compiled data.

### FIELD

Embodiments of the invention relate, generally, to adverse events, such as adverse drug events, and, in particular, to automatic surveillance and tracking of adverse events.

### BACKGROUND

Adverse drug events have been defined as injuries resulting from medical intervention related to a drug. An adverse drug event may be as mild as a skin rash resulting from a topical therapy or as serious as death as a result of anaphylaxis. Adverse drug events make up a subset of all adverse events that may occur within a medical facility (e.g., hospital, physician's office, surgery center, etc.) and are specific to medications. Other adverse events may include, for example, surgical site infections, formation of decubitis ulcers, birth trauma, injury to neoate, or the like. Adverse drug events include events that are a result of errors in medication prescribing, dispensing, monitoring and/or administration, as well as adverse drug reactions, which are unintended reactions to medications properly prescribed and administered.

In addition to the potential harm caused to the patient, adverse events may be associated with increased costs to the healthcare provider, with payment penalties from third-party payors, as well as, lengthened hospital, or other medical facility, stays. It is, therefore, an object of many medical facilities to reduce the number of adverse events, including adverse drug events, that occur within the facility. These facilities are challenged with the task of attempting to identify these events, formulate and implement patient safety strategies and demonstrate improvements in these outcomes.

National organizations that focus on patient safety have made recommendations for facilities to implement processes in order to identify adverse events and actively attempt to reduce the occurrence rate and the severity of outcomes. For example, the Institute for Health Improvement (IHI) has developed a methodology for identifying and tracking adverse drug events using adverse drug event trigger events. These trigger events include medications, lab results, and other data (nursing documentation, physician notes, etc.), which may be indicators that the patient has experienced an adverse drug event. The IHI recommends a sampling and manual chart review methodology for identifying the rate and level of harm associated with adverse drug events.

As a result, many facilities are using manual systems, voluntary reporting and limited chart review for adverse drug event capture, validation and management. Some of the limitations that exist in relation to these methodologies include, for example, the high cost and effort required for chart review, under identification of events, a potentially long lag time between event occurrence and adverse drug event evaluation, and variations in data modeling.

A need, therefore, exists for an improved technique for capturing, tracking and analyzing the occurrence of adverse drug, or similar, events within a medical facility that will more effectively assist the medical facility in improving its performance in relation to these events.

### BRIEF SUMMARY

In general, embodiments of the present invention provide an improvement by, among other things, providing an automatic surveillance and tracking system for detecting adverse events, automatically generating one or more performance metrics associated with the detected adverse events, and enabling the performance of an in depth root cause analysis of the detected adverse events. In particular, according to embodiments of the present invention, for each patient admitted to a medical facility (e.g., hospital, physician's office, surgery center, etc.) clinical, operational and financial data may be automatically gathered in relation to that patient. This information may include, for example, patient demographic information; information associated with drug(s) administered (e.g., time and/or dose administered), labs ordered and/or lab results received, and/or admittance and discharge (e.g., time admitted and discharged, to and from what department admitted/discharged, etc.); the identity of the attending physician and/or ordering practitioner, cost information, and/or the like.

One or more trigger rules may be automatically applied to the gathered information in order to identify any suspected adverse events, such as an adverse drug event. These trigger rules may be based on a specific combination of one or more trigger events that have been identified as indicative of an adverse drug event (e.g., administration of a particular drug, receipt of a particular lab result, etc.). For example, the combination of trigger events may take into consideration the sequence and/or timing of the trigger events (e.g., administering drug X or receiving lab result Y after administering drug Z, administering drug A less than 12 hours after patient was admitted to the emergency department, etc.). Using a generated list of suspected adverse drug events, a medication safety specialist may then review the causality and severity associated with the trigger events in order identify one or more confirmed adverse drug events.

Information corresponding to the patients in association with which the suspected and confirmed adverse drug events occurred may be compiled in order to generate one or more performance metrics that can be used, among other things, to evaluate the performance of the medical facility. These metrics may include, for example, the average rate of suspected and confirmed adverse drug events, the additional cost and increased length of stay associated with suspected and confirmed adverse drug events, and/or the like. Each performance metric may further be drilled down into in order to analyze the trends associated with suspected and confirmed adverse drug events and their impact, as well as to evaluate, for example, the performance of different departments and/or physicians within a facility (e.g., which facilities or departments have a higher than average number of suspected or confirmed adverse drug events, and what is the financial impact of that; which physicians have a less than average number of suspected or confirmed adverse drug events and what savings can be attributed to the practices of that physician, etc.).

In accordance with one aspect, a system is provided for automatically detecting and tracking adverse events. In one embodiment, the system may include one or more data sources configured to provide a combination of clinical, operational and financial data associated with respective patients of a plurality of patients. The system may further include a network entity in electronic communication with respective data sources in order to receive at least part of the combination of data. The network entity may be configured to apply one or more trigger rules to the combinations of data in order to identify one or more suspected adverse events. The network entity may further be configured to receive an indication of one or more confirmed adverse events from among the one or more suspected adverse events, and to automatically compile at least part of the combination of data associated with respective patients in association with which the confirmed adverse events occurred. The system may further include a user device in electronic communication with the network entity, wherein the user device is configured to enable performance of a root cause analysis of the compiled data.

In accordance with another aspect, a method is provided for automatically detecting and tracking adverse events. In one embodiment, the method may include: (1) receiving a combination of clinical, operational and financial data associated with respective patients of a plurality of patients; (2) applying one or more trigger rules to the combinations of data in order to identify one or more suspected adverse events, wherein at least one trigger rule is configured to determine whether a particular sequence of events has occurred with respect to the patient; (3) receiving an indication of one or more confirmed adverse events from among the one or more suspected adverse events; and (4) automatically compiling at least part of the combination of data associated with respective patients in association with which the confirmed adverse events occurred, thereby facilitating performance of a root cause analysis of the compiled data.

According to yet another aspect, a computer program product is provided for automatically detecting and tracking adverse events. The computer program product contains at least one computer-readable storage medium having computer-readable program code portions stored therein. The computer-readable program code portions of one embodiment include: (1) a first executable portion for receiving a combination of clinical, operational and financial data associated with respective patients of a plurality of patients; (2) a second executable portion for applying one or more trigger rules to the combinations of data in order to identify one or more suspected adverse events, wherein at least one trigger rule is configured to determine whether a particular sequence of events has occurred with respect to the patient; (3) a third executable portion for receiving an indication of one or more confirmed adverse events from among the one or more suspected adverse events; and (4) a fourth executable portion for automatically compiling at least part of the combination of data associated with respective patients in association with which the confirmed adverse events occurred, thereby facilitating performance of a root cause analysis of the compiled data.

According to another aspect, another method is provided for automatically detecting and tracking adverse events. In one embodiment, the method may include: (1) receiving a combination of clinical, operational and financial data associated with respective patients of a plurality of patients; (2) applying one or more trigger rules to the combinations of data in order to identify one or more suspected adverse events; (3) receiving an indication of one or more confirmed adverse events from among the one or more suspected adverse events; (4) automatically compiling at least part of the combination of data associated with respective patients in association with which the confirmed adverse events occurred; and (5) automatically generating one or more performance metrics based at least in part on the compiled data, wherein the performance metrics comprise a cost or a length of stay associated with confirmed adverse events corresponding to one or more severity levels, event categories, or drug classes.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram of one type of system that would benefit from embodiments of the present invention;

FIG. 2 is a block diagram of a warehouse, or similar network entity, of one embodiment of the present invention;

FIG. 3 is a schematic block diagram of an entity capable of operating as a warehouse, or similar network entity, in accordance with embodiments of the present invention;

FIG. 4 is a flow chart illustrating the process of automatic surveillance and tracking of adverse drug events in accordance with embodiments of the present invention;

FIGS. 5A-5C illustrate the process of creating or defining a trigger rule used to detect suspected adverse drug events in accordance with embodiments of the present invention;

FIG. 6 illustrates a Medication Safety Scorecard in accordance with an embodiment of the present invention; and

FIGS. 7A & 7B illustrate potential techniques for drilling down into a performance metric in accordance with embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overall System and Network Entity:

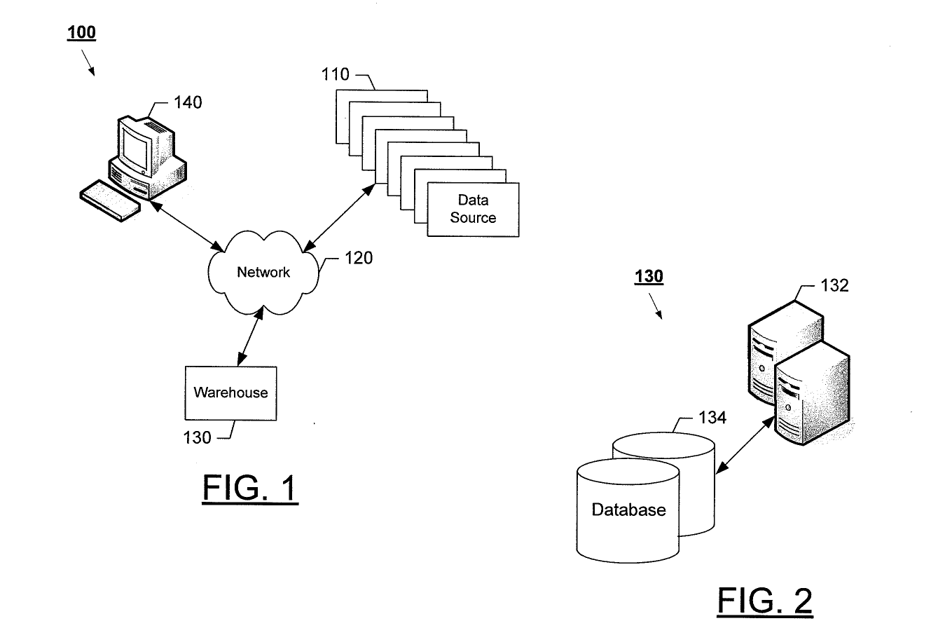

Referring to FIG. 1, an illustration of one type of system that would benefit from embodiments of the present invention is provided. While the following description assumes that the system is used to automatically detect and track adverse drug events, as one of ordinary skill in the art will recognize other types of adverse events may likewise be detected and tracked using the system of embodiments of the present invention. For example, the system may be used to detect adverse nursing, surgical, or other similar healthcare-related events. Based on the foregoing, embodiments of the present invention are not limited to application in relation to adverse drug events.

As shown in FIG. 1, the system may include one or more data sources 110 in electronic communication with a warehouse 130 over a communications network 120 in order to provide clinical, operational and/or financial data, or the like, to the warehouse 130. The communication network may include any wired or wireless communication network including, for example, a wired or wireless Local Area Network (LAN), Wide Area Network (WAN), Personal Area Network (PAN), or the like.

The data sources 110 may include, for example, any information system configured to provide clinical, operational and/or financial data associated with each of a plurality of patients to the warehouse 130 at least for the purpose of detecting a suspected adverse drug event. For example, the data sources 110 may include patient accounting systems, pharmacy information systems, nursing documentation systems, medication administration systems, lab information systems, emergency department management systems, or the like. Each system may be associated with the same or different vendor and may provide the same or different types and formats of information to the warehouse 130. The data provided to the warehouse 130 may include, for example, patient demographic information (e.g., age, gender, etc.), coded descriptions of the patient condition(s) and of procedures performed on the patient, charges for services provided to the patient, information associated with drug(s) administered to the patient (e.g., time and/or dose administered), information regarding labs ordered and/or lab results received in association with the patient, information regarding admittance and/or discharge of the patient (e.g., time admitted and/or discharged, to and/or from what department admitted/discharged, etc.), the identity of the attending physician (i.e., physician primarily responsible for the care of the patient) and/or ordering practitioner (e.g., practitioner responsible for ordering drug(s) administered) associated with the patient, cost information, and/or the like.

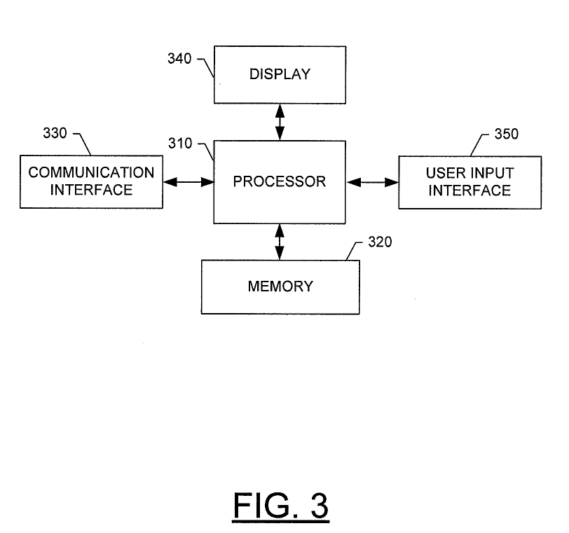

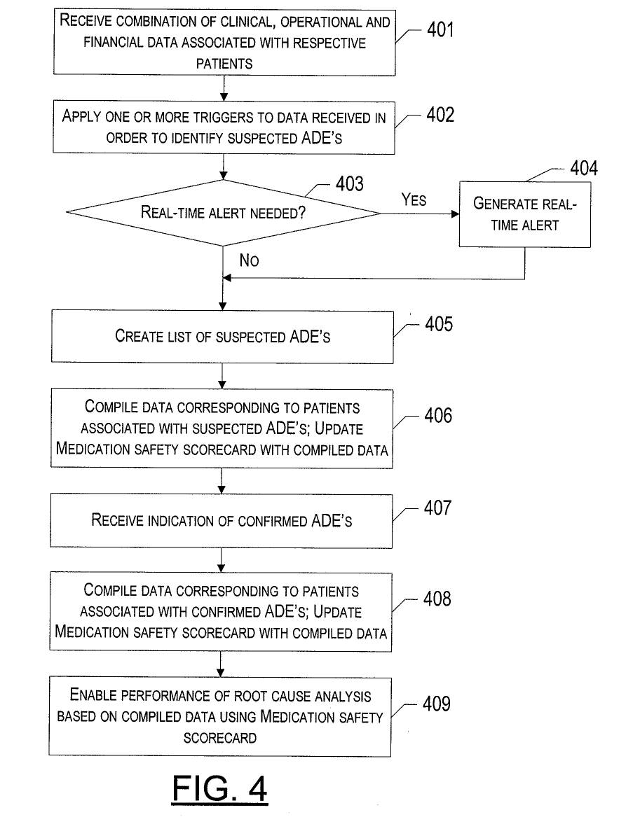

The warehouse 130, embodiments of which are shown in more detail in FIGS. 2 and 3, may include one or more servers 132, or similar network entities, operably connected to one another and to one or more remote or integral databases 134, or similar data collection devices. While not shown in FIG. 2, the servers 132 may be in communication with one another, as well as with one or more of the databases 134, over the same or different communication network 120. In one embodiment, the databases 134 may store the data received from the data sources 110, as well as instructions for applying various trigger rules to the received data in order to identify suspected adverse drug events. These instructions may be executed by one or more of the servers 132, or similar network entities, of the warehouse 130. In particular, while reference is made below with respect to FIG. 4 of the steps taken or instructions performed by the “warehouse,” as one of ordinary skill in the art will recognize, because the warehouse may include more than one server, or similar network entity, each step or instructions may be taken or performed by the same or different server, or similar network entity, of the warehouse and, in particular, by a processor or similar means operating on the server, or similar network entity.

One or more of the databases 134 may further store, and one or more of the servers 132 may further execute, various instructions for collecting and analyzing data associated with patients in association with which a suspected and/or confirmed adverse drug event has occurred. The system of this embodiment may further include a user device 140 (e.g., personal computer (PC), laptop, personal digital assistant (PDA), notebook, tablet, etc.) in electronic communication with the warehouse 130 for the purpose of enabling performance of a root cause analysis of the collected or compiled data.

Referring now to FIG. 3, a block diagram of an entity capable of operating as a warehouse 130 is shown in accordance with one embodiment of the present invention. The entity capable of operating as a warehouse 130 may include various means for performing one or more functions in accordance with embodiments of the present invention, including those more particularly shown and described herein. It should be understood, however, that the entity may include alternative means for performing one or more like functions, without departing from the spirit and scope of the present invention. As shown, the entity capable of operating as a warehouse 130 can generally include means, such as a processor 310, for performing or controlling the various functions of the entity. In one embodiment, the processor is in communication with or includes memory 320, such as volatile and/or non-volatile memory that stores content, data or the like. For example, the memory 320 typically stores content transmitted from, and/or received by, the entity. Also for example, the memory 320 typically stores software applications, instructions or the like for the processor to perform steps associated with operation of the entity in accordance with embodiments of the present invention.

For example, the memory 320 may store software applications, instructions or the like for the processor to apply one or more trigger rules to a combination of data received from the one or more data sources 110 in order to identify one or more suspected adverse drug events. In one embodiment at least one trigger rule may be configured to determine whether a particular sequence of events has occurred with respect to the patient. The memory 320 may further store software applications, instructions or the like for the processor to receive an indication of one or more confirmed adverse drug events from among the one or more suspected adverse drug events, and to automatically compile at least part of the combination of data associated with respective patients in association with which the confirmed adverse drug events occurred. Finally, according to one embodiment, the memory 320 may further store software applications, instructions or the like for the processor to automatically generate one or more performance metrics based at least in part on the compiled data associated with the patients who suffered a confirmed adverse drug event, as well as patients who did not. The performance metrics may include, for example, a cost or a length of stay associated with the confirmed adverse drug events corresponding to one or more severity levels, event categories, or drug classes.

In addition to the memory 320, the processor 310 can also be connected to at least one interface or other means for displaying, transmitting and/or receiving data, content or the like. In this regard, the interface(s) can include at least one communication interface 330 or other means for transmitting and/or receiving data, content or the like, as well as at least one user interface that can include a display 340 and/or a user input interface 350. The user input interface, in turn, can comprise any of a number of devices allowing the entity to receive data from a user, such as a keypad, a touch display, a joystick or other input device.

### Method of Detecting and Tracking Adverse Drug Events

Referring now to FIG. 4, the operations are illustrated that may be taken in order to perform automatic surveillance and tracking of adverse drug events in accordance with embodiments of the present invention. As noted above, while FIG. 4 and the corresponding discussion assumes the surveillance and tracking of adverse drug events, as one of ordinary skill in the art will recognize, the surveillance and tracking of other types of adverse events (e.g., nursing, surgical, etc.) likewise fall within the scope of embodiments of the present invention.

As shown, the process may begin at Block 401 when the warehouse (e.g., a processor or similar means operating on a server or other network entity), receives clinical, operational and financial data associated with each of a plurality of patients who have been admitted to a particular medical facility (e.g., hospital, physician's office, surgical center, etc.). As discussed above with regard to FIG. 1, the data may be received from any combination of one or more data sources including, for example patient accounting systems, pharmacy information systems, nursing documentation systems, medication administration systems, lab information systems, emergency department management systems, and/or the like. As also discussed above with regard to FIG. 1, the data received may, for example, include, for each patient, some combination of patient demographic information; information regarding drug(s) administered, labs ordered and/or lab results received, and/or admittance and discharge; the identity of the attending physician and/or ordering practitioner, costing information and/or the like.

While not shown, in one embodiment, the information received from the various data sources may be standardized either when transmitted or upon receipt by the warehouse. For example, according to one embodiment, as data is received, the warehouse (e.g., processor or similar means) may map the received data to an appropriate standardized coding system. Standardized coding systems may exist, for example, for drugs (e.g., U.S. Food and Drug Administration (FDA) National Drug Codes (NDCs), the AMERICAN SOCIETY OF HEALTH-SYSTEM PHARMACISTS® (ASHP), AMERICAN HOSPITAL FORMULARY SERVICE® (AHFS), etc.), lab tests and/or results (e.g., the Regenstrief Institute, Inc.'s Logical Observation Identifiers Names and Codes LOINC®, etc.), causality factors (e.g., Naranjo Adverse Drug Reaction Probability Scale) (discussed below), severity of illness categories (e.g., 3M APR DRG Classification System (APR DRGs)), level of harm (e.g., National Coordinating Council for Medication Error Reporting and Prevention (NCC MERP) Index for Categorizing Medication Errors) (discussed below), and/or the like. Alternatively, according to another embodiment, in order to transmit data to the warehouse, the data sources may, themselves, be required to use the appropriate standardized codes. In either embodiment, by standardizing and, therefore, normalizing the data collected by the warehouse, embodiments of the present invention provide for the comparison and benchmarking of gathered information and performance metrics calculated (discussed below) across multiple, distinctly operated organizations.

While further not shown, upon receiving the clinical, operational and financial data associated with each patient, the warehouse (e.g., processor or similar means operating on a server or similar network entity) may analyze and manipulate the data received in order to create a longitudinal record associated with each patient. In other words, a record may be created that tracks all (or most) events (e.g., data/time/facility/department admitted, drugs administered, lab tests ordered, lab tests received, procedures performed, date/time discharged, physicians seen, etc.) associated with or occurring in relation to the patient while being treated at one or more medical facilities on one or more occasions. In addition, the warehouse (e.g., processor or similar means) may perform various calculations associated with the costs associated with treatment of the patient. For example, the warehouse (e.g., processor or similar means) may determine, from the information received, the costs associated with caring for the patient, as well as, the expected payment to be received from the patient or third-party payor.

Returning now to FIG. 4, at Block 402, the warehouse (e.g., processor or similar means operating on a server or similar network entity) may apply one or more trigger rules to the data received in order to identify any suspected adverse drug events. As discussed above, an adverse drug event is an injury caused by the use of a drug or medication. Adverse drug events may include anything from rashes to death caused by an overdose. According to one embodiment of the present invention, a plurality of trigger rules may be created or defined for detecting when a suspected adverse drug event may have occurred based, for example, on the trigger events established by the Institute for Safe Medication Practices (ISMP). As one of ordinary skill in the art will recognize, ISMP trigger events include, for example, specific medications, lab results, and other data (e.g., nursing documentation, physician notes) which may be indicators that the patient has experienced an adverse drug event. According to embodiments of the present invention, the ISMP, or similar, trigger events may be combined and manipulated in order to define a plurality of trigger rules that can be applied to the extensive information received by the warehouse in order to identify suspected adverse drug events.

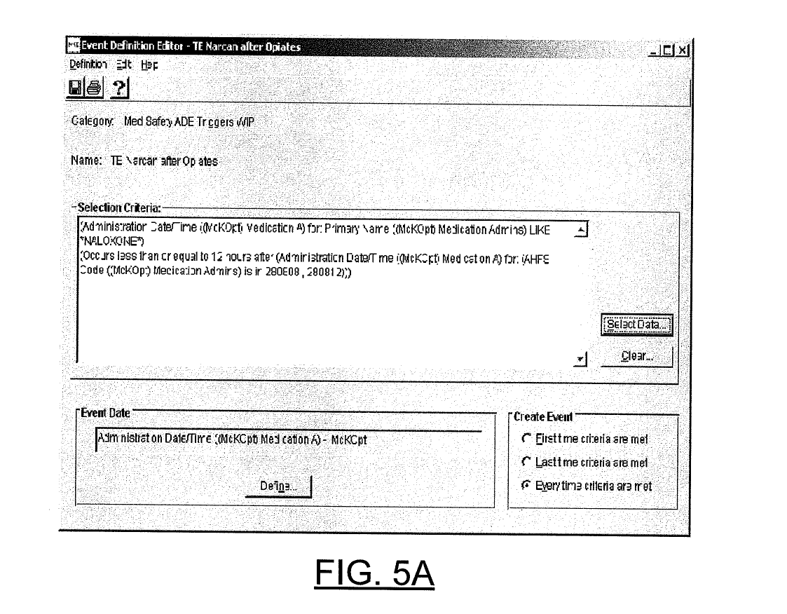

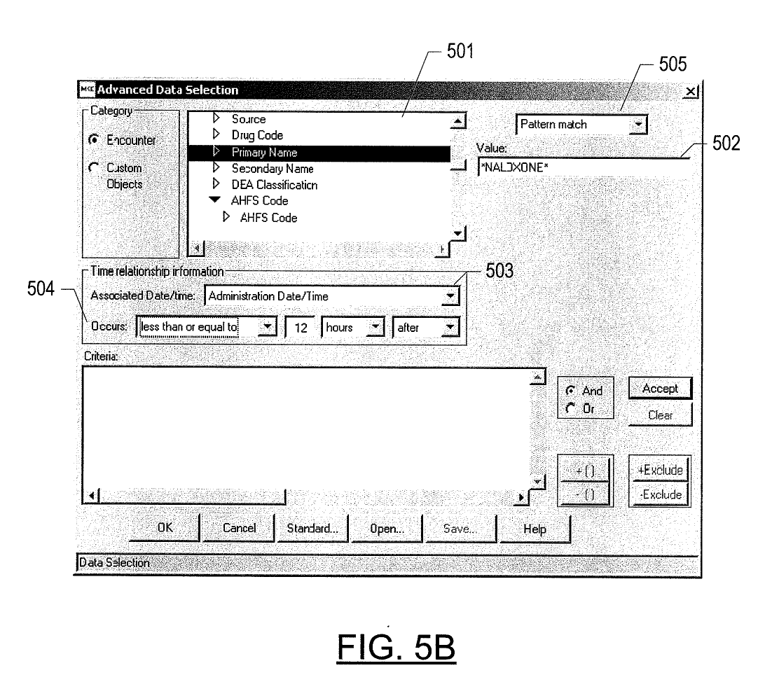

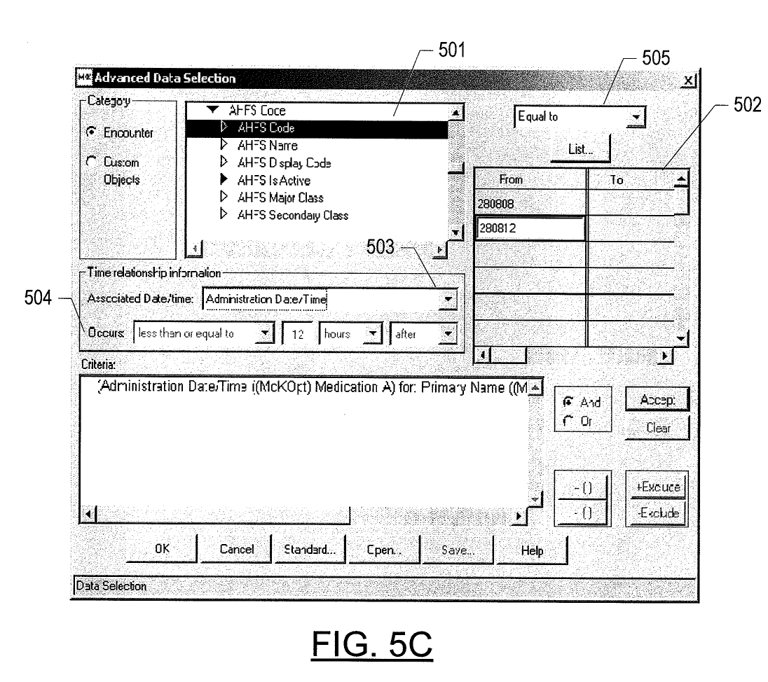

To illustrate, reference is made to FIGS. 5A-5C, which provide one example of the process that may be used to create or define a trigger rule in accordance with embodiments of the present invention. In particular, as shown in FIG. 5A, a trigger rule may be created that identifies a suspected adverse drug event each time the drug Naloxone is administered less than or equal to 12 hours after administering a drug that is either an opiate agonist or an opiate partial agonist (i.e., a drug having an AHFS code of 280808 or 280812).

In order to create this trigger event rule, the user may first define the criteria of the trigger rule (e.g., administering of the drug Naxolone and the administration of an opiate), as well as the connection between the first criterion and the second criterion (e.g., less than or equal to 12 hours after). As shown in FIG. 5B, the user may define the criteria of interest by first selecting, for example from a menu 501, a data element from within the warehouse, or previously defined trigger event. For example, when defining a drug as the first criterion, the user may specify whether the drug will be identified based on a drug code, a primary name associated with a drug, a secondary name associated with a drug, a Drug Enforcement Administration (DEA) classification associated with a drug, an AHFS code associated with a drug, or the like. In the example shown, the user has selected the primary name, in order to indicate that the first trigger criterion will be defined based on the primary name of a drug. The user may then employ a relational operator 505 (e.g., equal to, greater than, etc.) to specify the value(s) of interest. As shown, the user has indicated that the value of the primary name of the drug to look for is a pattern match on “Naloxone” 502. Values may be input, for example, individually or as part of a list (as shown in FIG. 5C).

The user may then use one or more drop down menus 503 to define the relevant date/time associated with the first criterion (e.g., the “Associated Date/Time”). In this example, the relevant date/time is the date/time of administration of the drug having a primary name of Naxolone. Other Associated Dates/Times may include, for example, the date on which the drug had been scheduled to be administered, or the date on which it was ordered, and/or the like. The second criterion (e.g., the administering of an opiate) and its relevant date (date/time of administration) may be defined in a similar manner, as shown in FIG. 5C.

Finally, the user may use one or more drop down menus 504 to define the relationship between the first criterion and the second criterion. In this example, the relationship is associated with the timing of the criteria. In particular, the first criterion (i.e., administration of the drug having a primary name matching “Naxolone”) should occur less than or equal to 12 hours after the second criterion (i.e., administration of the drug having an AHFS code equal to 280808 or 280812).

As shown, according to one embodiment of the present invention, one or more trigger rules may be based on the occurrence of a particular sequence of events in relation to a patient (e.g., administering of a particular drug or receipt of a particular lab result after administering another drug). Similarly, one or more trigger rules may be based on the specific time at which one or more events occurred with respect to another event. For example, one trigger rule may identify a suspected adverse drug event when a particular drug was administered or a lab result was received more than a predetermined period of time after the patient was admitted. More specifically, other examples of trigger rules generated may include, for example, the administration of Vitamin K less than or equal to four hours following the administration of Coumadin; receipt of a low glucose lab result less than or equal to 12 hours after the administration of Insulin, or the like.

Similarly, this type of sequencing and/or timing information may be used to exclude certain combinations of trigger events from identifying a suspected adverse drug event. For example, if a trigger event (e.g., administering of a particular drug, or receipt of a particular lab result that may be indicative of an adverse drug event) occurs within 24 hours of a patient being admitted to the medical facility, it is unlikely that the trigger event was the result of an adverse drug event. Specifically, Narcan is an antidote for an overdose of a narcotic. If a patient is administered Narcan shortly after being admitted, it is likely that the patient came in with a drug overdose and, therefore, that he or she did not suffer an adverse drug event. Otherwise (e.g., if Narcan is administered more than 24 hours after the patient was admitted) it is more likely indicative of an adverse drug event. As a result of the foregoing, trigger rule logic may exclude specific events that occur within that specific time frame (e.g., within 24 hours of admittance).

The exclusions are not limited to timing and/or sequencing information. For example, it may be determined that particular trigger events are not very predictive of adverse drug events in association with patients admitted to the emergency department (as opposed to another department of the medical facility). As a result, one trigger rule may be to exclude specific trigger events that occur in relation to patients admitted to the emergency department.

According to embodiments of the present invention, these trigger rules may be tailored over time based on the desires and needs of the particular medical facility. In addition, the trigger rules may be altered as additional information, for example, nursing documentation, becomes available to the warehouse that can be used in the trigger rules. The trigger rules may further change based on an evaluation of each trigger rule's predictive value (e.g., trigger rules that have been determined to have a low predictive value may be modified or removed).

By combining, manipulating and tailoring trigger events based, for example, on time and sequence information known to the warehouse, embodiments of the present invention attempt to incorporate the reasoning of a pharmacist or physician to the trigger events. Thus the ability of the system to identify suspected adverse drug events is improved over a system that merely applies industry standard trigger events directly.

As one of ordinary skill in the art will recognize, the foregoing examples of trigger rules and their creation were provided for exemplary purposes only and provide only a few examples of the criteria, logic, combinations, and rules for combining criteria that may be used to create the various trigger rules used by the warehouse. For example, while many of the foregoing examples assume that trigger rules include two trigger events, as one of ordinary skill in the art will recognize, any number and combination of criteria may be used in order to create a trigger rule in accordance with embodiments of the present invention. Embodiments of the present invention should, therefore, not be limited to the specific number, type or interrelationship of trigger events defined in association with FIGS. 5A-5C or described above.

Returning now to FIG. 4, at this point it may be determined whether it is necessary or desirable to generate a real-time alert to the caregiver (e.g., nurse, physician, allied health professional, etc.) in association with one or more identified suspected adverse drug events. (Block 403). In particular, according to one embodiment, one or more trigger rules may be identified as having a high probability of positively predicting an adverse drug event (e.g., a probability that exceeds some predefined threshold). This may be evaluated based on historical experience (e.g., by analyzing the volume of suspected adverse drug events that resulted in confirmed adverse drug events (discussed below)), or the like. When a suspected adverse drug event is identified based on the application of one of these identified trigger rules, a real-time alert may be beneficial. Alternatively, or in addition, it may be determined that the symptoms or adverse reactions associated with certain adverse drug events are particularly severe and/or are better able to be mitigated or even prevented the sooner a physician or other healthcare provider is able to intervene. As a result, a real-time alert may likewise be desirable when it is suspected that one of these adverse drug events has occurred.

If it is determined, at Block 403, that a real-time alert is needed or would be beneficial, the warehouse (e.g., processor or similar means operating on a server or similar network entity) may generate, at Block 404, a real-time alert to be issued to a caregiver. The real-time alert may be issued to the healthcare provider via any number of different means. For example, the real-time alert may be displayed on a user device display screen; transmitted via email, short message service (SMS) message, multimedia message service (MMS) message, or the like; printed; communicated as a voice message to a cellular telephone; transmitted as a text message to a pager; and/or the like.

If it is determined that a real-time alert is not needed or beneficial, and/or after the real-time alert has been generated, the warehouse (e.g., processor or similar means operating on a server or similar network entity) may, at Block 405, create a list of suspected adverse drug events to be distributed to a medication safety specialist (e.g., a pharmacist or other caregiver specifically trained in medication safety). The list may be provided in an electronic format that allows the medication safety specialist to categorize, reorder and review suspected drug events.

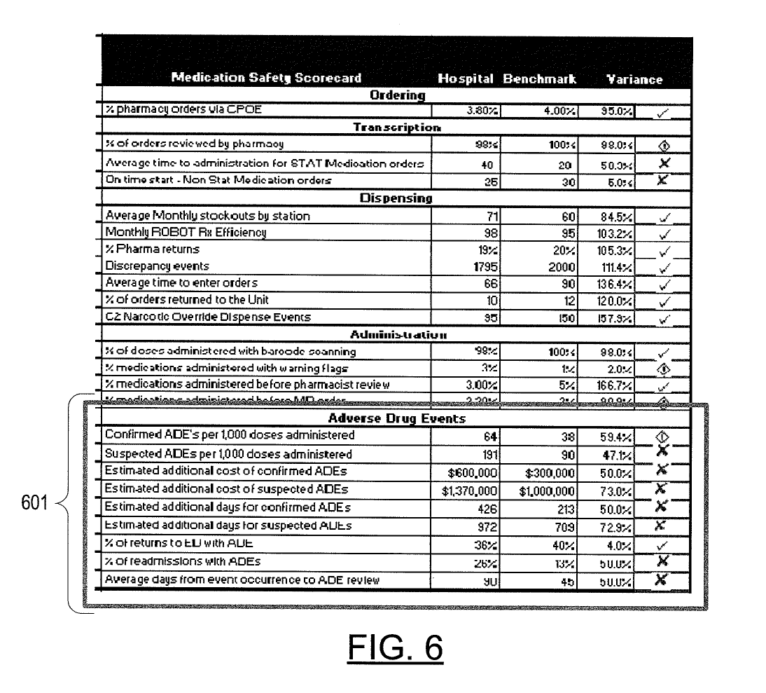

In addition to creating the list of suspected adverse drug events, according to one embodiment, data corresponding to the patients in association with which a suspected adverse drug event occurred may be compiled and used to update a Medication Safety Scorecard, an example of which is shown in FIG. 6. (Block 406). In particular, according to one embodiment of the present invention, the clinical, operational and financial data discussed above (e.g., patient demographic information; information regarding drug(s) administered, labs ordered and/or lab results received, admittance and discharge, patient conditions and/or procedures performed; the identity of the attending physician and/or ordering practitioner, cost information, or the like) may be gathered in order to generate one or more performance metrics 601 associated with suspected adverse drug events. As shown in FIG. 6, these performance metrics 601 may include, for example, the rate of suspected adverse drug events (e.g., per 1000 doses of medication administered), the estimated additional cost associated with suspected adverse drug events (e.g., the costs associated with a patient with a suspected adverse drug event minus the costs associated with a similar patient without a suspected adverse drug event), the estimated additional days (i.e., length of stay (LOS)) associated with suspected adverse drug events (e.g., the LOS associated with a patient with a suspected adverse drug event minus the LOS associated with a similar patient without a suspected adverse drug event), or the like. As one of ordinary skill in the art will recognize, other performance metrics may similarly be generated based on the information gathered without departing from the spirit and scope of embodiments of the present invention.

As described in more detail below, the Medication Safety Scorecard may be used by healthcare workers, as well as medical facility administrators, and/or other users to evaluate the medical facility's performance with regard to suspected adverse drug events. In particular, as is also discussed in more detail below, according to embodiments of the present invention, a user may drill down into the various performance metrics of the Medication Safety Scorecard in order to evaluate trends and analyze the various factors contributing to or associated with each performance metric (e.g., excess cost and/or length of stay associated with an adverse drug event based on medical facility, department, physician, etc.).

Returning to FIG. 4, using the list created at Block 405, the medication safety specialist may identify one or more confirmed adverse drug events from among the suspected adverse drug events and provide an indication of those confirmed adverse drug events, which is received by the warehouse (e.g., processor or similar means operating on a server or similar network entity) at Block 407. In particular, according to one embodiment of the present invention, the medication safety specialist may use the Naranjo Adverse Drug Reaction (ADR) Probability Scale to determine how likely it was that an adverse drug event was the cause of the trigger event. As one of ordinary skill in the art will recognize, the Naranjo ADR Probability Scale requires that the medication safety specialist answer a list of ten questions including, for example, whether the adverse event appeared after the suspected drug was administered, and whether the reaction reappeared when a placebo was given. A different point value is assigned based on the answer of each question, and the sum of the individual point values dictates whether it was highly probable, probable, possible or doubtful that an adverse drug event occurred.

The medication safety specialist may further use the NCC MERP Index for Categorizing Medication Errors in order to categorize the severity of the trigger or adverse event. These categories include, for example, temporary harm, permanent harm, or death. The medication safety specialist may further categorize the adverse event as preventable, not-preventable, or unclear. These categories may enable the medical facility to address process improvement efforts towards those adverse events that may actually be prevented in the future.

According to one embodiment, the determination of whether a suspected adverse drug event constitutes a confirmed adverse drug event may be based on the determined causality factor in combination with the determined severity. In one embodiment, the higher the degree of causality (e.g., probable or highly probable) the less severe the adverse event need be (e.g., Error, No Harm) in order for the suspected adverse drug even to be considered a confirmed adverse drug event, and vice versa.

In addition to the foregoing, according to one embodiment of the present invention, one or more confirmed adverse drug events may be identified that do not correspond to the suspected adverse drug events detected by the automatic surveillance system. In particular, according to one embodiment, caregivers (e.g., physicians, pharmacists, nurses, allied health professionals, etc.) may manually identify an adverse drug event based on their own analysis of the patient and/or his or her chart. An indication of this confirmed adverse drug event may likewise be received by the warehouse (e.g., processor or similar means operating on the server or similar network entity) at Block 407.

Once the indication of confirmed adverse drug events has been received, the warehouse (e.g., processor or similar means operating on the server or similar network entity) may again compile data for use in updating the Medication Safety Scorecard (at Block 408), but this time with respect to patients in association with which confirmed adverse drug events have occurred. As above, the data gathered may include any of the clinical, operational and financial data received by the warehouse from the various data sources, as well as information regarding the causality, severity and preventability categorizations determined by the medication safety specialist. The relevant performance metrics 601 of the Medication Safety Scorecard may include, for example, the rate of confirmed adverse drug events (e.g., per 1000 doses of medication administered), the estimated additional cost associated with confirmed adverse drug events, the estimated additional days (i.e., length of stay (LOS)) associated with confirmed adverse drug events, the percentage of returns to the emergency department with an adverse drug event, the percentage of readmissions with an adverse drug event, the average number of days between adverse drug event occurrence and adverse drug event review, or the like.

As an example of how the warehouse (e.g., processor or similar means) may calculate the performance metrics, according to one embodiment, the estimated additional cost associated with confirmed adverse drug events may be calculated by subtracting the average cost per patient who did not suffer a confirmed adverse drug event from the average cost per similar patient who did suffer a confirmed adverse drug event, then multiplying by the number of patients who suffered confirmed adverse drug events. Similarly, the estimated additional days (LOS) associated with confirmed adverse drug events may be calculated by subtracting the average LOS of a patient without a confirmed adverse drug event from the average LOS of a similar patient with a confirmed adverse drug event, then multiplying by the number of patients with confirmed adverse drug events. As above, as one of ordinary skill in the art will recognize, other performance metrics may similarly be generated based on the information gathered without departing from the spirit and scope of embodiments of the present invention.

As briefly mentioned above, once the data has been compiled and the above-described performance metrics, or the like, have been calculated, embodiments of the present invention may enable, at Block 409, performance of a root cause analysis of suspected and confirmed adverse drug events using the data compiled and the Medication Safety Scorecard. In particular, according to embodiments of the present invention, a healthcare worker, healthcare facility administrator, and/or other user, may perform any number of different statistical analyses using the wealth of information received by the warehouse. For example, a user may drill down into any of the performance metrics discussed above with regard to both suspected and confirmed adverse drug events in order to analyze those metrics with respect to the facility and/or department to which the patient was admitted, the date of admittance, the attending physician, the drug(s) administered, the severity of the resulting illness, the ordering practitioner, the type of trigger event or trigger rule associated with the adverse drug event, the principal diagnosis of the patient, the principal procedure(s) undergone by the patient, and/or the like.

According to embodiments of the present invention, the Medication Safety Scorecard may be fully interactive, presenting metric trend lines, and allowing users to drill into metrics in detail to understand the factors that may be contributing to preventable adverse drug events. Other sections of the scorecard may provide indicators of processes that may contribute to, or help to prevent, medication errors and/or adverse drug events. Additionally, a user may use the information gathered, analyzed and presented in order to compare process, outcomes and costs associated with adverse drug events, and comparable cases without such events. Embodiments of the present invention further support extensive population segmentation and process analysis to understand the characteristics of similar cases without an adverse drug event, with one, and with more than one. This, in turn, can assist with process improvements designed to reduce both the initial incidence and the incidence of repeat events.

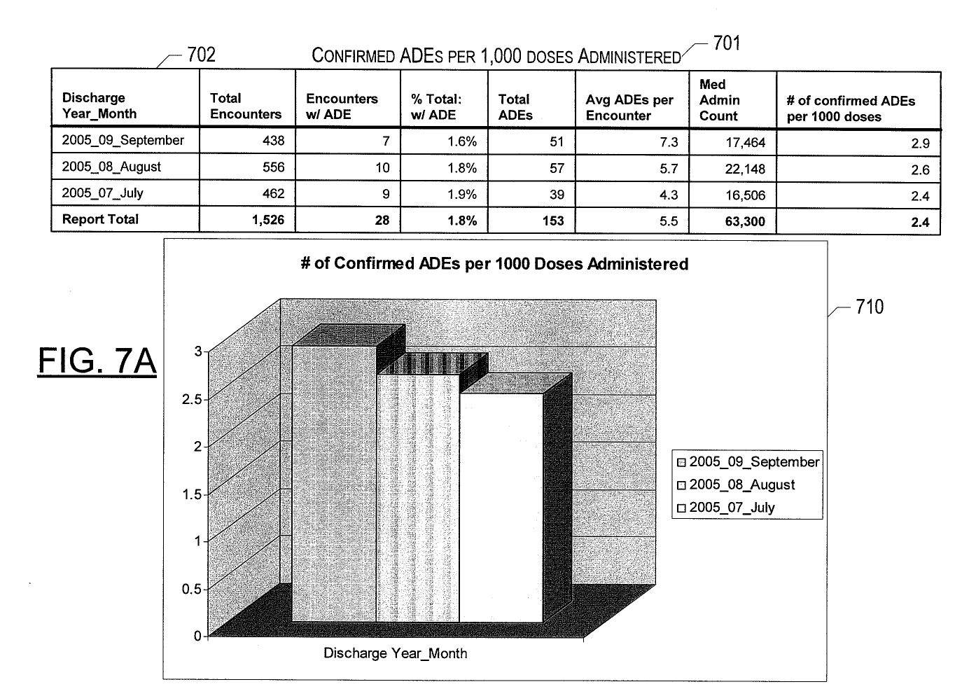

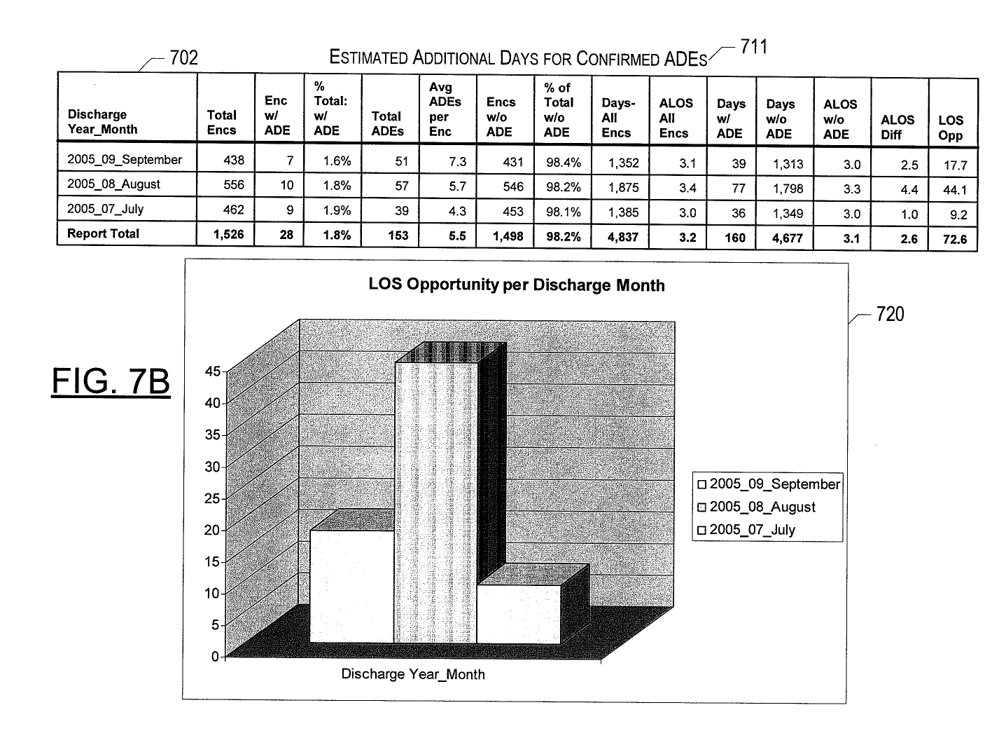

To illustrate, reference is made to FIGS. 7A & 7B, which illustrate potential techniques for drilling down into a performance metric in accordance with embodiments of the present invention. As shown in FIG. 7A, the user may take a closer look at the rate of confirmed adverse drug events (e.g., number of confirmed adverse drug events per 1000 doses of medication) 701. In particular, the user may break down the rate of confirmed adverse drug events by the month and year in which the patients were discharged (e.g., September of 2005, August of 2005 and July of 2005) 702. For each discharge month, the user may look at the total number of encounters (e.g., patients seen), the number of encounters with confirmed adverse drug events, the percentage of the total number of encounters with confirmed adverse drug events, the total number of confirmed adverse drug events, the average number of confirmed adverse drug events per encounter (e.g., the number of total confirmed adverse drug events divided by the number of encounters with confirmed adverse drug events), the total number of medications administered, the number of confirmed adverse drug events per 1000 doses, and/or the like. A graphical representation of any of the above calculations may be generated including, for example, as shown, the number of confirmed adverse drug events per 1000 doses 710. Similar calculations and graphical representations may likewise be calculated, for example, for each facility or each department within the facility (e.g., the average confirmed adverse drug event per encounter for each of the emergency department, oncology department, obstetrics, etc.), each attending physician, each drug class, and so on. Likewise, similar calculations and graphical representations may be generated in association with suspected adverse drug events.

Similarly, FIG. 7B illustrates one technique for drilling down into the estimated additional days associated with confirmed adverse drug events 711, again by the month and year in which the patient was discharged 702. In this instance, according to one embodiment, for each discharge month, in addition to looking at the total number of encounters, the number of encounters with confirmed adverse drug events, the percentage of the total number of encounters with confirmed adverse drug events, the total number of confirmed adverse drug events, and the average number of confirmed adverse drug events per encounter, the user may look at the number of encounters without confirmed adverse drug events, the percentage of the total number of encounters without confirmed adverse drug events, the number of days for all encounters (e.g., the sum of all days associated with all encounters within the given month), the average length of stay (LOS) associated with all encounters, the total number of days with and without confirmed adverse drug events (e.g., the sum of the LOS of each patient with and without a confirmed adverse drug event), the average LOS for patients without a confirmed adverse drug event, the average LOS difference (e.g., the difference between the average LOS of a patient without a confirmed adverse drug event and the average LOS of a similar patient with a confirmed adverse drug event), and the LOS opportunity (e.g., the number of patient care days that could theoretically be eliminated if all adverse drug events could be prevented, which may be calculated, for example, by multiplying the LOS difference by the number of encounters with a confirmed adverse drug event). As above, a graphical representation may be generated for any of the metrics calculated including, for example, as shown, the LOS opportunity for each discharge month 720.

The foregoing examples of drill down techniques, metrics calculated and graphical representations displayed for the user are provided for exemplary purposes only and should not be taken in any way as limiting the scope of embodiments of the present invention to the examples shown. As one of ordinary skill in the art will recognize, because the warehouse of embodiments of the present invention obtains clinical, operational and financial data from multiple disparate information systems operating throughout the medical facility, the warehouse may be able to perform countless meaningful calculations in order to enable the user to perform a substantive analysis of the root cause of the suspected and adverse drug events occurring within the facility. The user may look at trends associated with suspected and adverse drug events (e.g., physician A appears to have more confirmed adverse drug events, department B appears to have significantly less suspected adverse drug events, etc.), as well as the impact associated with those trends (e.g., the average cost or increased length of stay associated with the suspected and confirmed adverse drug events occurring in relation to a particular drug class or procedure). The user may further be able to analyze the procedures or events leading up to each adverse drug event in order to evaluate potential areas for improvement.

### CONCLUSION

As described above and as will be appreciated by one skilled in the art, embodiments of the present invention may be configured as a system or method. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 310 discussed above with reference to FIG. 3, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 310 of FIG. 3) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system comprising:
one or more data sources configured to provide a combination of clinical, operational and financial data associated with respective patients of a plurality of patients;
a network entity in electronic communication with respective data sources in order to receive at least part of the combinations of data, said network entity configured to:
apply one or more trigger rules to the combinations of data received in order to identify one or more suspected adverse events;
receive an indication of one or more confirmed adverse events from among the one or more suspected adverse events; and
automatically compile at least part of the combination of data associated with respective patients in association with which the confirmed adverse events occurred; and
a user device in electronic communication with the network entity, said user device configured to enable performance of a root cause analysis of the compiled data.

2. The system of claim 1, wherein the one or more suspected adverse events comprise one or more suspected adverse drug events, and wherein the one or more confirmed adverse events comprise one or more confirmed adverse drug events.

3. The system of claim 2, wherein the combination of data comprises data associated with one or more of patient demographics, one or more drugs administered, one or more lab results received, one or more procedures, one or more patient conditions, date and time of admittance, date and time of discharge, and one or more costs incurred.

4. The system of claim 3, wherein the data associated with one or more drugs administered comprises a time and a dosage of respective drugs administered.

5. The system of claim 2, wherein the network entity is configured to apply at least one trigger rule that is configured to determine whether a particular sequence of events occurred with respect to the patient.

6. The system of claim 2, wherein the network entity is configured to apply at least one trigger rule that is configured to determine whether one or more events occurred at a specific time with respect to the occurrence of another event.

7. The system of claim 2, wherein the one or more confirmed adverse drug events are determined based at least in part on a causality factor and a severity level associated with respective suspected adverse drug events, and wherein the network entity is configured to compile data comprising the causality factor and severity level associated with respective confirmed adverse drug events.

8. The system of claim 2, wherein the network entity is further configured to:
receive an indication of one or more confirmed adverse drug events not associated with the one or more suspected adverse drug events.

9. The system of claim 2, wherein the network entity is further configured to:
automatically compile at least part of the combination of data associated with respective patients in association with which the suspected adverse drug events occurred.

10. The system of claim 9, wherein in order to compile at least part of the combination of data associated with respective patients in association with which suspected and confirmed adverse drug events occurred, the network entity is further configured to create a Medication Safety Scorecard comprising one or more performance metrics associated with the one or more suspected and confirmed adverse drug events.

11. The system of claim 10, wherein the one or more performance metrics comprise one or more of a rate of suspected and confirmed adverse drug events, a length of stay associated with suspected and confirmed adverse drug events, an excess cost associated with suspected and confirmed adverse drug events, a percentage of returns to an emergency department with a confirmed adverse drug event, a percentage of readmissions with a confirmed adverse drug event, and an average number of days from a confirmed adverse drug event occurrence to an adverse drug event review.

12. The system of claim 11, wherein in order to enable performance of a root cause analysis of the compiled data, the user device is further configured to evaluate data underlying the one or more performance metrics in order to analyze one or more factors contributing to or associated with respective adverse drug events.

13. The system of claim 12, wherein the one or more factors comprise one or more of a facility in which the patient is located, a department in which the patient is located, a month in which the suspected or confirmed adverse drug event occurred, a day on which the suspected or confirmed adverse drug event occurred, a time at which the suspected or confirmed adverse drug event occurred, and a physician responsible for administering care for the patient.

14. The system of claim 12, wherein in order to enable performance of a root cause analysis of the compiled data, the user device is further configured to analyze one or more events leading up to respective adverse drug events and one or more trends associated with suspected and confirmed adverse drug events.

15. The system of claim 2, wherein at least one trigger rule has been identified as having a probability of accurately identifying an adverse drug event that exceeds a predefined threshold, and wherein the network entity is further configured to:
generate an alert when a suspected adverse drug event is identified as a result of applying the identified trigger rule.

16. A method comprising:
receiving a combination of clinical, operational and financial data associated with respective patients of a plurality of patients;
applying one or more trigger rules to the combinations of data in order to identify one or more suspected adverse events, wherein at least one trigger rule is configured to determine whether a particular sequence of events has occurred with respect to the patient;
receiving an indication of one or more confirmed adverse events from among the one or more suspected adverse events; and
automatically compiling at least part of the combination of data associated with respective patients in association with which the confirmed adverse events occurred, thereby facilitating performance of a root cause analysis of the compiled data.

17. The method of claim 16, wherein the one or more suspected adverse events comprise one or more suspected adverse drug events, and wherein the one or more confirmed adverse events comprise one or more confirmed adverse drug events.

18. The method of claim 17, wherein the combination of data comprises data associated with one or more of patient demographics, a time and a dosage associated with one or more drugs administered, one or more lab results received, one or more procedures, one or more patient conditions, date and time of admittance, date and time of discharge, and one or more costs incurred.

19. The method of claim 18, wherein the at least one trigger rule is configured to determine whether a second drug was administered or a particular lab result was received following the administering of a first drug.

20. The method of claim 18, wherein at least another one of the trigger rules is configured to determine whether one or more events occurred at a specific time with respect to the occurrence of another event.

21. The method of claim 20, wherein the at least another one of the trigger rules is configured to determine whether a drug was administered or a lab result was received more than a predetermined period of time after the patient was admitted.

22. The method of claim 17 further comprising:
receiving a definition of a trigger rule.

23. A computer program product for comprising at least one computer-readable storage medium having computer-readable program code portions stored therein, the computer-readable program code portions comprising:
a first executable portion for receiving a combination of clinical, operational and financial data associated with respective patients of a plurality of patients;
a second executable portion for applying one or more trigger rules to the combinations of data in order to identify one or more suspected adverse events, wherein at least one trigger rule is configured to determine whether a particular sequence of events has occurred with respect to the patient;
a third executable portion for receiving an indication of one or more confirmed adverse events from among the one or more suspected adverse events; and
a fourth executable portion for automatically compiling at least part of the combination of data associated with respective patients in association with which the confirmed adverse events occurred, thereby facilitating performance of a root cause analysis of the compiled data.

24. The computer program product of claim 23, wherein the one or more suspected adverse events comprise one or more suspected adverse drug events, and wherein the one or more confirmed adverse events comprise one or more confirmed adverse drug events.

25. The computer program product of claim 24, wherein the combination of data comprises data associated with one or more of patient demographics, a time and a dosage associated with one or more drugs administered, one or more lab results received, one or more procedures performed, one or more patient conditions, date and time of admittance, date and time of discharge, and one or more costs incurred.

26. The computer program product of claim 25, wherein at least another one of the trigger rules is configured to determine whether one or more events occurred at a specific time with respect to the occurrence of another event.

27. A method comprising:
receiving a combination of clinical, operational and financial data associated with respective patients of a plurality of patients;
applying one or more trigger rules to the combinations of data in order to identify one or more suspected adverse events;
receiving an indication of one or more confirmed adverse events from among the one or more suspected events; and
automatically compiling at least part of the combination of data associated with respective patients in association with which the confirmed adverse events occurred; and
automatically generating one or more performance metrics based at least in part on the compiled data, wherein the performance metrics comprise a cost or a length of stay associated with confirmed adverse events corresponding to one or more severity levels, event categories, or drug classes.

28. The method of claim 27, wherein the one or more suspected adverse events comprise one or more suspected adverse drug events, and wherein the one or more confirmed adverse events comprise one or more confirmed adverse drug events.

29. The method of claim 29, wherein the one or more confirmed adverse drug events are determined based at least in part on a causality factor and a severity level associated with respective suspected adverse drug events, and wherein automatically compiling data comprises compiling the causality factor and severity level associated with respective confirmed adverse drug events.

30. The method of claim 28 further comprising:
automatically compiling at least part of the combination of data associated with respective patients in association with which the suspected adverse drug events occurred.

31. The method of claim 30, wherein automatically generating the one or more performance metrics further comprises automatically generating one or more of a rate of suspected and confirmed adverse drug events, an overall length of stay associated with suspected and confirmed adverse drug events, an overall excess cost associated with suspected and confirmed adverse drug events, a percentage of returns to an emergency department with a confirmed adverse drug event, a percentage of readmissions with a confirmed adverse drug event, and an average number of days from a confirmed adverse drug event occurrence to an adverse drug event review.
